(19) United States
(12) Patent Application Publication
(10) Pub. No.: US 2005/0175824 A1
(43) Pub. Date: Aug. 11, 2005

(54) Method for forming multilayer circuit structure and base having multilayer circuit structure

(76) Inventors: Yasuhiro Wakizawa, Tokyo (JP); Akihiko Furuya, Tokyo (JP); Keiichirou Yasuda, Kumamoto (JP); Tomoyuki Baba, Kumamoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/514,421

(22) PCT Filed: Mar. 31, 2003
(86) PCT No.: PCT/JP03/04114

(30) Foreign Application Priority Data
May 17, 2002 (JP) 2002-142564

(51) Int. Cl. B05D 5/12; B32B 3/00

(52) U.S. Cl. 428/209; 427/96.1

(57) ABSTRACT

The invention relates to a method for forming a multilayer circuit structure and to a substrate having a multilayer circuit structure. Its object is to increase the adhesion of the conductor circuit layer while the surface of the electrical insulating layer is kept smooth. A curable composition film containing an insulating polymer and a curing agent is formed as the outermost layer of an inner layer board, then a compound having a structure capable of coordinating to a metal is brought into contact with the surface of the curable composition film, then the curable composition film is cured to form an electrical insulating layer, then the surface of the resulting electrical insulating layer is hydrophilicated, then a metal thin-film layer of an ethylenediaminetetraacetate-copper complex is formed on the surface of the electrical insulating layer, and then a conductor circuit layer containing the metal thin-film layer is formed.

### TECHNICAL FIELD

The present invention relates to a method for forming a multilayer circuit structure and to a substrate having a multilayer circuit structure. More precisely, the invention relates to a method for forming a multilayer circuit structure excellent in adhesion of wiring patterns and characterized by the processing step for forming conductor circuit layers on smooth electrical insulating layers, and to a substrate having a multilayer circuit structure.

### BACKGROUND ART

As electronic equipment becomes further miniaturized and multifunctional, higher density has been requested also for the circuit boards used in the electronic equipment.

To meet the requirement of making the density of the circuit boards higher, the circuit boards are generally multilayered.

The multilayer circuit board is typically obtained by laminating an electrical insulating layer on the surface of an inner layer board on which conductor circuit layers are formed on the outermost surface thereof and forming another conductor circuit layer on the electrical insulating layer, and it is also possible to further laminate a number of electrical insulating layers and conductor circuits as necessary.

In the multilayer circuit boards of the type, adhesion between the electrical insulating layers and the conductor circuit patterns formed thereon, or that is, the pattern adhesion is important in order to ensure the life of the multilayer circuit boards.

For obtaining the pattern adhesion, various methods of roughening electrical insulating layers are widely employed (if necessary, refer to JP-A 11-23649, 11-286562, Japanese Patent No. 2,877,110). With reference to FIG. 5 and FIG. 6, one example is described below.

FIG. 5(a) is Referred to:

For example, an epoxy resin layer 32 is laminated on a double-sided copper-clad laminate 31 having a copper circuit (not shown) formed on its surface, and then exposed to UV laser to thereby form via-holes (not shown) for connection to the copper circuit formed on the double-sided copper-clad laminate 31.

FIG. 5(b) is Referred to:

Next, this is dipped in a solution comprising NaOH and a surfactant as the main ingredients thereof, and the epoxy resin layer 32 is thereby swollen.

Thus swollen, the epoxy resin layer 32 has a swollen layer formed on the surface thereof.

FIG. 5(c) is Referred to:

Next, the double-sided copper-clad laminate 31 is dipped in a desmearing solution, an oxidizing solution that comprises a mixture of KMnO₄ and NaOH, whereby the residue generated in the laser processing of the inside of the via-holes is removed, and the surface of the epoxy resin layer 32 is roughened to have fine recesses formed therein.

Next, the double-sided copper-clad laminate 31 is washed with water, and then this is dipped in a hydrazine-containing neutralizing solution and neutralized therein. Next, the double-sided copper-clad laminate 31 is again washed with water, and then dipped in a degreasing solution and degreased therein.

FIG. 5(d) is Referred to:

Next, the double-sided copper-clad laminate 31 is washed with water, and then dipped in a predipping solution so as to improve its compatibility with a catalyst solution in the next catalyst step. Next, the double-sided copper-clad laminate 31 is washed with water, and then dipped in a catalyst solution whereby an Sn/Pd colloid substance [(Pd)ₘ(Sn)ₙ(Cl)₁⁻] 35 is deposited on the exposed surfaces of the copper circuit, the epoxy resin layer 32 and the swollen layer 33.

FIG. 6(e) is Referred to:

Next, the double-sided copper-clad laminate 31 is washed with water, and then dipped in an accelerator solution to remove Sn from the colloid substance, whereby the Pd catalyst 36 alone is kept adhered to the exposed surfaces of the copper circuit, the epoxy resin layer 32 and the swollen layer 33.

FIG. 6(f) is Referred to:

Next, the double-sided copper-clad laminate 31 is washed with water, and then processed for electroless copper plating with a copper sulfate-based, electroless copper plating solution that comprises copper sulfate as the main ingredient thereof, whereby a plate seed layer of an electroless copper plate layer 37 is formed on the exposed surfaces of the copper circuit, the epoxy resin layer 32 and the swollen layer 33.

FIG. 6(g) is Referred to:

Next, the double-sided copper-clad laminate 31 with the electroless copper plate layer 37 formed thereon is processed for electrolytic copper plating to thereby form an electrolytic copper plate layer 38 on the exposed plate seed layer and to fill the via-holes, and then the electrolytic copper plate layer 38 and the electroless copper plate layer 37 are etched to a predetermined pattern to form copper wiring. This step is repeated for the number of necessary times, and a multilayer circuit substrate is thereby completed. Another method for improving the adhesion is also under investigation, which comprises applying an adhesive for electroless plating that contains polymer component such as rubber and resin, onto the roughened electrical insulating layer (if necessary, refer to JP-A 2001-192844, 2001-123137, 11-4069).

Further, the present applicant et al. employed polyimide as the resin layer, applied metal ions to the ring-opened residue of the polyimide and made them adsorbed by the residue and reduced, and have thereby attained an adhesion strength of 0.6 kgf/cm that will be necessary for practical use (if necessary, refer to Kumamoto-ken Chiiki Kesshu-gata Kyodo Kenkyu, “Development of Ultra-Precision Semiconductor Measurement Technology”, 2nd Technology Symposium, 2001).

However, according to the treatment after the formation of the electrical insulating layer, sufficient pattern adhesion could not be always obtained when there are some changes in ambient temperature and humidity, and therefore, the life of the circuit boards is shortened. When the surface roughness of the roughened surface is unsatisfactory, then the adhesion is low and the reliability may lower.

In addition, when a conductor circuit is formed by etching the conductor layer formed on the roughened electrical insulating layer as in the above, then there is a problem in that the processing accuracy of the conductor circuit is poor since the penetration of the etching solution used differs depending on the width of the distance of the conductor circuit. This situation is described with reference to FIG. 7.

FIG. 7(a) is Referred to:

After an electroless copper plate layer 42 is formed on a surface-roughened resin layer 41 according to an electroless plating process, an electrolytic copper plate layer 44 is formed thereon by utilizing a plate resist pattern 43 according to an electrolytic plating process.

FIG. 7(b) is Referred to:

Next, after the plate resist pattern 43 is removed, the exposed electroless copper plate layer 42 is removed to thereby form wirings 45 to 47 of the electrolytic copper plate layer 44/electroless copper plate layer 42, and the wirings 45 to 47 are electrically separated from each other.

FIG. 7(c) is Referred to:

However, the etching solution flow is not smooth in the narrow distance between the wirings 45 and 46, and the etching rate is thereby lowered. Therefore, the etching time must be prolonged in order that the exposed electroless copper plate layer 42 is completely removed and the wirings 45 and 46 are electrically separated from each other.

In particular, since the surface of the resin layer 41 is roughened, the thickness of the electroless copper plate layer 42 would be from 3 to 8 μm in the area where it fills the recesses, and the etching time shall be long in order to remove the electroless copper plate layer 42 of from 3 to 8 μm in thickness.

If so, in the area where the distance between the wirings 46 and 47 is broad, the etching solution flow is smooth and the etching rate is therefore high, and, as a result, the wiring 47 is overetched, and the pattern profile is worsened and the processing accuracy is therefore lowered.

Furthermore, when the surface of the electrical insulating layer is roughened for improving the adhesion, then the conductor circuit layer formed is not flat, and this causes a problem in that the electric signal transmission characteristic of the conductor circuit is worsened owing to the influence of the surface effect thereon in a high-frequency region of a level of GHz or more.

Concretely, on a level of 1 GHz, the electric signal may concentrate to a thickness of about 2 μm from the surface of the conductor layer, and therefore the effective transmission line length may be long if the surface roughness is too great, and as a result, the electric signal transmission characteristic of the device may be worsened.

To solve the problem, one of the present inventors has found that, when a layer containing a compound capable of coordinating to a metal is formed on the surface of a resin layer for solving the problem of adhesion depression, in forming wiring not roughening the surface of the resin layer, then the adhesion can be ensured (if necessary, refer to Japanese Patent Application No. 2001-268847). In that situation, this time, the present inventors have noted the plating condition in this process and have made investigations for improving the peeling strength as one index of adhesion.

### DISCLOSURE OF THE INVENTION

FIG. 1 is a flowchart showing the principle constitution of the present invention. With reference to FIG. 1, the means for solving the problems in the invention are described.

FIG. 1 is Referred to:

(1) The invention is a method for forming a multilayer circuit structure, which comprises steps of forming a curable composition film that contains an insulating polymer and a curing agent, as the outermost layer of an inner layer board (step A), then bringing a compound that has a structure capable of coordinating to a metal, into contact with the surface of the curable composition film (step B), then curing the curable composition film to form an electrical insulating layer (step (C), then hydrophilicating the surface of the resulting electrical insulating layer (step D), then forming a metal thin-film layer of an ethylenediaminetetraacetate-copper complex on the surface of the electrical insulating layer (step F), and then forming a conductor circuit layer that contains the metal thin-film layer (step G).

In that manner, the present inventors have assiduously studied so as to obtain a multilayer circuit board that keeps a higher pattern adhesion on a smooth electrical insulating layer, and, as a result, have found that, when a thin metal film is formed of a specific complex in forming an electrical insulating layer and when plating is grown thereon to form a conductor circuit layer, then the above-mentioned objects can be attained, and have completed the present invention.

The inner layer board in this case is typically a printed circuit board, but may be a semiconductor board such as Si wafer.

Prior to the step F, a catalyst-imparting step (step E) is carried out. In the catalyst-imparting step, it is desirable that a catalyst having an alkali complex structure is used.

(2) In the above (1) of the invention, the hydrophilicating treatment (step D) is a step of bringing the electrical insulating layer into contact with a mixture solution that comprises from 65 g/liter to 150 g/liter of potassium permanganate and from 0.75 normalities to 1.5 normalities of an alkali hydroxide, for surface-treatment of the electrical insulating layer.

In that manner, it is desirable that the hydrophilication for removing the weak boundary layer is effected by the use of the high-concentration solution having the composition as above. More preferably, the treatment is a short-time treatment.

(3) In the above (1) or (2) of the invention, the curable composition film that contains an insulating polymer and a curing agent and is formed as the outermost layer of the inner layer board is formed according to any of a method of laminating any of a shaped film or sheet of a curable composition that contains an insulating polymer and a curing agent, on the inner layer board, or a method of by applying a varnish prepared by dissolving a curable composition containing an insulating polymer and a curing agent in a solvent, onto the surface of the inner layer board and drying it thereon.

(4) In any of the above (1) to (3) of the invention, the method includes a heating step (step H) after the formation of the conductor circuit layer (step G).

In that manner, heating after the formation of the conductor circuit layer further enhances the adhesion strength.

This will be because the chemical bonding may be promoted and the residual stress may be relieved.

(5) The invention also provides a substrate having a multilayer circuit structure, in which the multilayer circuit structure is manufactured according to the multilayer circuit structure-forming method of any of above (1) to (4).

In this case, when the inner layer board is a printed circuit board, then the “substrate” is to be a multilayer circuit board; and when the inner layer board is a semiconductor board, then the “substrate” is a semiconductor integrated circuit device.

### BRIEF DESCRIPTION OF THE DRAWINGS

FIG. 1 is a flowchart showing the principle constitution of the present invention.

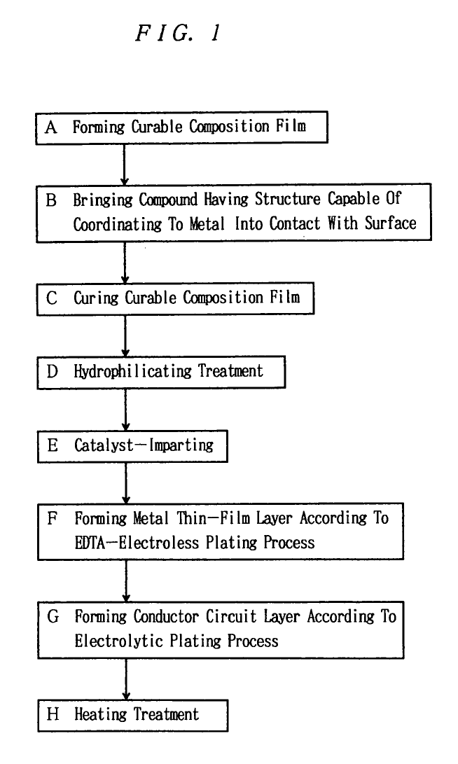

FIG. 2 is an explanatory view showing halfway the manufacturing process of one embodiment of the invention.

FIG. 3 is an explanatory view showing the manufacturing process after FIG. 2 of the embodiment of the invention.

FIG. 4 is an explanatory view showing the adhesion strength and the surface roughness Rₐ in Examples of the invention, Comparative Example and Reference Example.

FIG. 5 is an explanatory view showing halfway a conventional process of manufacturing a multilayer circuit board.

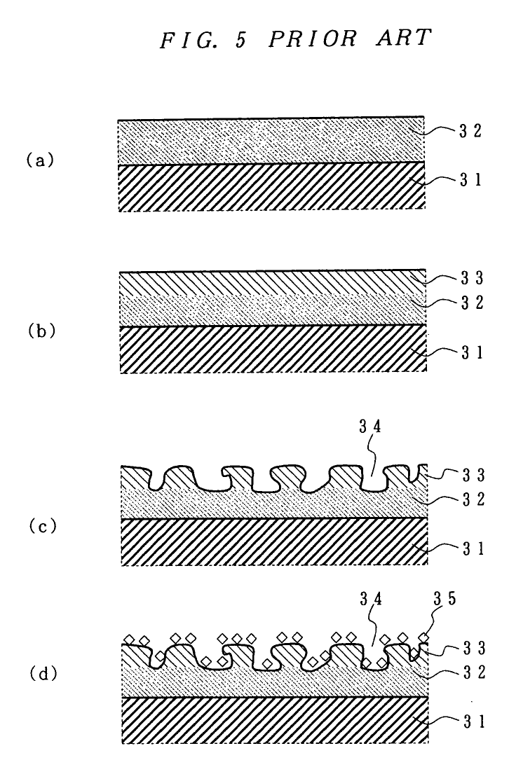

FIG. 6 is an explanatory view showing the conventional process after FIG. 5 of manufacturing a multilayer circuit board.

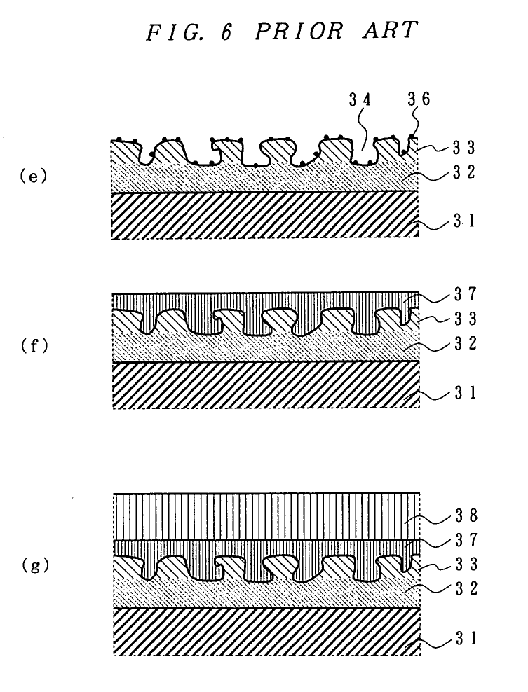

FIG. 7 is an explanatory view showing the problems with conventional surface-roughening treatment.

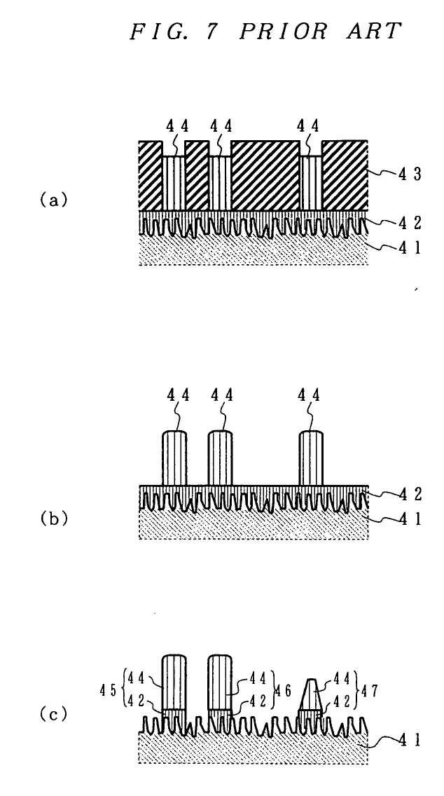

### BEST MODE FOR CARRYING OUT THE INVENTION

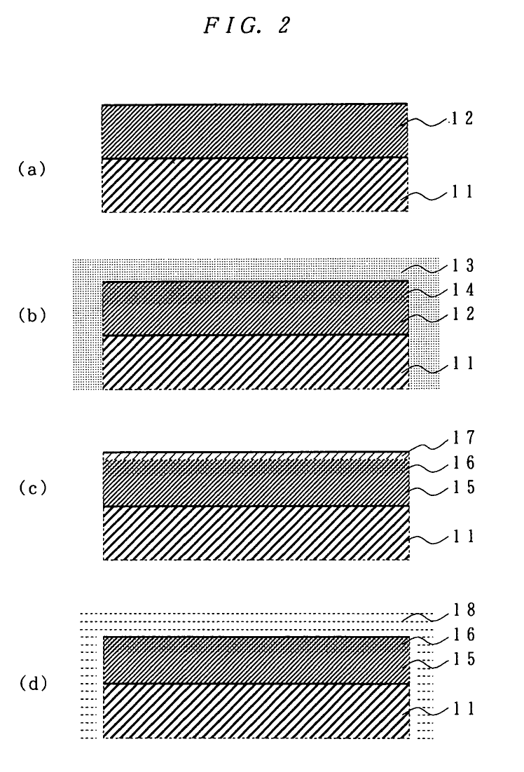

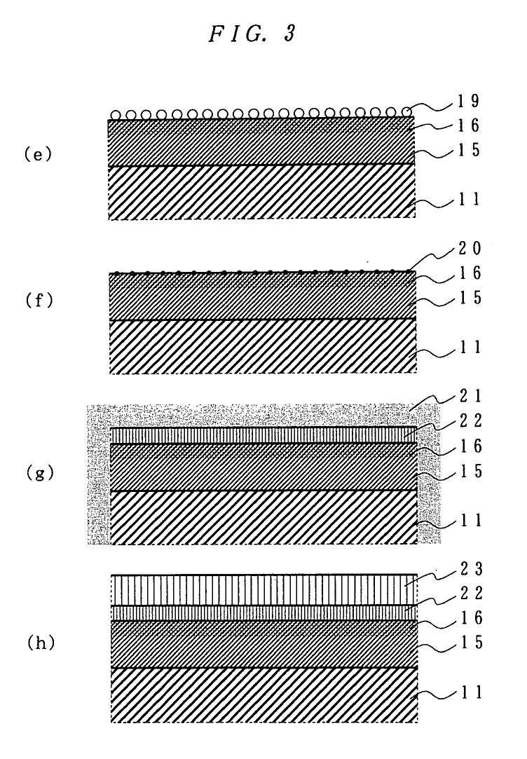

With reference to FIG. 2 and FIG. 3, one preferred process of carrying out the invention is described below.

FIG. 2(a) is Referred to:

(Step A)

First, a curable composition film 12 for forming an electrical insulating layer is formed on an inner layer board 11 such as a printed wiring board, a board with a conductor circuit of a conductive metal formed on the surface thereof.

In this case, the thickness of the printed wiring board to be the inner layer board 11 is, for example, from 50 μm to 2 mm, preferably from 60 μm to 1.6 mm, more preferably from 100 μm to 1 mm. In this, the thickness is 1 mm.

The curable composition film 12 in this case is a film of a curable composition that comprises an insulating polymer having an electrical insulating property and a curing agent.

The insulating polymer includes epoxy resins, maleimide resins (meth)acrylic resins, diallyl phthalate resins, triazine resins, alicyclic olefin polymers, aromatic polyether polymers, benzocyclobutene polymers, cyanate ester polymers, liquid crystal polymers, and polyimides.

Of those, preferred are alicyclic olefin polymers, aromatic polyether polymers, benzocyclobutene polymers, cyanate ester polymers or polyimides; more preferred are alicyclic olefin polymers or aromatic polyether polymers; and even more preferred are alicyclic olefin polymers.

The alicyclic olefin polymers include ring-opened polymers of norbornene monomers such as 8-ethyl-tetracyclo[4.4.0.1^{2,5}.1^{7,10}]-dodec-3-ene, and their hydrogenated derivatives; addition-polymers of norbornene monomers; addition-polymers of norbornene monomers and vinyl compounds; monocyclic cycloalkene polymers; alicyclic conjugated diene polymers; vinyl alicyclic hydrocarbon polymers and their hydrogenated derivatives; and aromatic ring-hydrogenated derivatives of aromatic olefin polymers.

Of those, preferred are ring-opened polymers of norbornene monomers and their hydrogenated derivatives, addition-polymers of norbornene monomers, addition-polymers of norbornene monomers and vinyl compounds, and aromatic ring-hydrogenated derivatives of aromatic olefin polymers; and more preferred are hydrogenated derivatives of ring-opened polymers of norbornene monomers.

Preferably, these polymers have a carboxyl group or a carboxylic acid anhydride residue that is bonded thereto through graft modification with a carboxylic acid or a carboxylic acid anhydride compound.

The curing agent may be any ordinary one, including ionic curing agents, radical curing agents and curing agents having both ionic and radical properties. In particular, preferred are polyepoxy compounds such as glycidyl ether epoxy compounds, e.g., bisphenol A bis(propylene glycol glycidyl ether)ether, alicyclic epoxy compounds, and glycidyl ester epoxy compounds.

To promote the curing reaction, for example, when a polyepoxy compound is used as the curing agent, it is desirable to use a curing promoter or a curing aid such as tertiary amine compounds or boron trifluoride complex compounds.

If desired, the curable composition for use in the invention may contain any other additives such as flame retardant, soft polymer, heat-resistant stabilizer, weather-resistant stabilizer, antioxidant, leveling agent, antistatic agent, slipping agent, antiblocking agent, antifogging agent, lubricant, dye, pigment, natural oil, synthetic oil, wax, emulsion, filler, UV absorbent, etc.

The method for forming the curable composition film 12 as the outermost layer of the inner layer board 11 is not specifically defined, which may be, for example, as follows:
<1> A method of laminating any of a shaped film or sheet of the above-mentioned curable composition on the inner layer board; or
<2> A method of by applying a varnish prepared by dissolving the curable composition in a solvent, onto the surface of the inner layer board and drying it thereon.

The method <1> is preferred as it readily gives a smooth face and facilitates multilayer formation.

The shaped film or sheet of the curable composition is generally formed according to a solution casting method or a melt casting method, and its thickness is generally from 0.1 to 150 μm, preferably from 0.5 to 100 μm, more preferably from 1.0 to 80 μm.

In the invention, preferably used is a support-sustained dry film that has a support attached to one face of the shaped film, in view of its operability. The support-sustained dry film may be produced, for example, by applying a varnish that is prepared by mixing the constitutive components of the curable composition in an organic solvent, for example, a hydrocarbon solvent such as xylene or a ketone solvent such as cyclopentanone, onto a support of a thermoplastic resin film such as polyethylene terephthalate film or a metal foil such as copper foil having a thickness of from 1 μm to 150 μm, in an ordinary manner, followed by drying it under a heating condition at 20 to 300° C. for 30 seconds to 1 hour or so to thereby remove the organic solvent.

The method of laminating the shaped article to the inner layer board 11 is not also specifically defined. In general, the two may be laminated under heat and pressure.

The method for heat and pressure is generally thermo-compression bonding (lamination) that may be attained by the use of a pressing machine such as pressure laminator, vacuum laminator, vacuum press, roll laminator.

Preferably, the thermo-compression bonding is effected in a reduced-pressure environment for facilitating the operation of wire embedding and for preventing generation of blisters, etc.

The thermo-compression bonding by the use of such a pressure machine is generally attained via a press plate. The temperature of the press plate during thermo-compression bonding generally falls between 30 and 250° C., preferably between 70 and 200° C.; the strength of the compression bonding generally falls between 10 kPa and 20 MPa, preferably between 100 kPa and 10 MPa; and the time for the compression bonding generally falls between 30 seconds and 5 hours, preferably between 1 minute and 3 hours.

When the thermo-compression bonding is attained in a reduced-pressure environment, the atmosphere is reduced to generally from 100 kPa to 1 Pa, preferably from 40 kPa to 10 Pa.

FIG. 2(b) is Referred to:

(Step B)

After the curable composition film 12 has been formed in the manner as above, and when a shaped article having a support such as a support-sustained dry film is used, then the support is peeled away, and a compound having a structure capable of coordinating to a metal is brought into contact with the surface of the film and a coordinating compound-infiltrated layer 14 is thus formed on the surface of the curable composition film 12.

In the invention, the compound having a structure capable of coordinating to a metal, or that is, the coordinating compound is a compound having a non-covalent electron pair, and it is preferably a nitrogen atom-containing heterocyclic compound in view of the adhesion thereof to electrical insulating layers.

The nitrogen atom-containing heterocyclic compound includes imidazoles such as 1-(2-aminoethyl)-2-methylimidazole; pyrazoles such as 1,3-dimethyl-4-carboxymethylpyrazole; triazoles such as 1-amino-2-mercapto-1,2,4-triazole; and triazines such as 2-di-n-butylamino-4,6-dimercapto-S-triazine.

These compounds may have an amino group, a thiol group and a carboxyl group.

The method of bringing the coordinating compound into contact with the surface of the curable composition film is not specifically defined.

Concretely, there are mentioned a dipping method that comprises dissolving a coordinating compound in water or an organic solvent to prepare its solution, followed by dipping the inner layer board 11 with a curable composition film 12 formed thereon, in the coordinating compound solution 13; and a spraying method that comprises spraying the surface of the curable composition film 12 on the shaped article-laminated inner layer board 11 with the coordinating compound solution 13 through a spraying machine or the like. The contact operation may be effected once or repeatedly twice or more.

The temperature for the contact may be freely selected in consideration of the boiling point and the melting point of the coordinating compound and its solution, and the operability and the producibility with it. In general, the temperature falls between 10 and 100° C., preferably between 15 and 65° C.

The contact time may be freely selected in accordance with the amount of the coordinating compound that is to be adhered to the surface of the shaped article, the concentration of the solution of the compound, and the producibility productivity with it. In general, the time falls between 0.1 and 360 minutes, preferably between 0.1 and 60 minutes.

After this, in order to remove the excess coordinating compound from the board, an inert gas such as nitrogen may be jetted to the board, or the board may be dried in an oven, or it may be washed with water and then heated and dried.

The solvent to be used for dissolving the coordinating compound may be any one selected so that it does not readily dissolve the curable composition film but dissolves the coordinating compound. For example, it includes water and polar solvents, such as ethers, e.g., tetrahydrofuran; alcohols, e.g., ethanol and isopropanol; ketones, e.g., acetone; and cellosolves, e.g., ethyl cellosolve acetate.

In this case, the concentration of the coordinating compound in the coordinating compound solution 13 is not specifically defined. In view of the operability of the solution in this step, the concentration of the coordinating compound is generally from 0.001 to 70% by weight, preferably from 0.01 to 50% by weight.

FIG. 2(c) is Referred to:

(Step C)

Next, the method of curing the curable composition film 12 formed in the manner as above to form an electrical insulating layer 15 may be suitably selected depending on the type of the curing agent. In general, it may be effected by heating at 30 to 400° C., preferably at 70 to 300° C., more preferably at 100 to 200° C.; and the curing time generally falls between 0.1 and 5 hours, preferably between 0.5 and 3 hours.

In this case, the heating method is not specifically defined. For example, the heating may be effected in an oven or the like.

In the step C, it is believed that the layer 16 that contains the compound capable of coordinating with a metal may be formed inside, and a weak boundary layer 17 of a low-molecular component may be formed as the surface.

When a multilayer circuit board is formed, the conductor circuit layer in the inner layer board 11 is connected to the conductor circuit layer that is to be formed in the step G to be mentioned hereinunder. Therefore, in this case, openings for forming via-holes are formed in the electrical insulating layer 15 before a metal thin-film layer is formed.

The method for forming the openings for via-holes is not specifically defined. For example, they may be formed through physical treatment of drilling, laser application or plasma etching.

FIG. 2(d) is Referred to:

(Step D)

Next, a mixture solution comprising a predetermined concentration of potassium permanganate and a predetermined concentration of an alkali hydroxide, or that is, a hydrophilicating solution 18 is brought into contact with the surface of the electrical insulating layer 15.

In the step D, it is believed that the weak boundary layer 17 formed on the surface of the electrical insulating layer 15 may be removed.

The mixture solution of potassium permanganate and alkali hydroxide in the step D may be prepared by dissolving potassium permanganate and alkali hydroxide in water followed by adjusting their concentration to the following:

For example, the concentration of potassium permanganate is generally from 65 g/liter to 150 g/liter, preferably from 70 g/liter to 100 g/liter.

The concentration of alkali hydroxide is generally from 0.75 normalities to 1.5 normalities, preferably from 0.95 normalities to 1.2 normalities. Heretofore, the concentration is preferably higher. Within the concentration range as above, good adhesion may be obtained.

The alkali hydroxide is a hydroxide of an alkali metal, and sodium hydroxide and potassium hydroxide are preferred.

The method of bringing the hydrophilicating solution 18 of a mixture solution of potassium permanganate and alkali hydroxide, into contact with the electrical insulating layer 15 is not specifically defined. For example, herein employable are the same methods as those mentioned for the step B.

Needless-to-say, the method for the step B may be the same as or different from the process for the step D.

The time for which the aqueous solution that contains potassium permanganate and alkali hydroxide is brought into contact with the electrical insulating layer 15 is generally from 0.5 minutes to 10 minutes, preferably from 1 minute to 7 minutes. Heretofore, the time is preferably shorter. The temperature of the aqueous solution may fall between 70° C. and 90° C., preferably between 75° C. and 85° C.

After this treatment, it is desirable that the board is brought into contact with a mixed acid solution of hydroxylamine sulfate and sulfuric acid so as to be neutralized and reduced, and further after it, the board is preferably washed with water.

After the electrical insulating layer is brought into contact with the mixture solution of potassium permanganate and alkali hydroxide in the manner as above, if desired, the electrical insulating layer may be dried, for example, in the same manner as in the step B.

In general, treatment of plating catalyst impartation or catalyst activation is effected prior to electroless plating. The plating catalyst is a metal compound that is to be a reducing catalyst having the effect of plating metal deposition in an electroless plating solution. The metal includes Pd, Pt, Au, Ag, Ir, Os, Ru, Sn, Zn, Co, etc.

For enhancing the adhesion, it is desirable to use an organic metal complex or a metal salt capable of forming a metal through reduction, as the metal compound. Concretely, it includes Pd-amine complex, palladium sulfate, palladium chloride, etc.

The method of catalyst impartation and catalyst activation comprises, for example, dipping the board in a solution prepared by dissolving a metal compound in water or in an organic solvent such as alcohol or chloroform to have a concentration of from 0.001 to 10% by weight, to thereby impart a plating catalyst to the board, followed by reducing the metal to activate the catalyst.

If desired, the solution may contain an acid, an alkali, a complexing agent, a reducing agent, etc.

FIG. 3(e) is Referred to:

(Step E)

Next, the electrical insulating layer 15 formed in the manner as above is made to absorb an alkali complex-structured Pd catalyst, Pd-amine complex catalyst 19.

FIG. 3(f) is Referred to:

Next, the Pd-amine complex catalyst 19 is reduced to form a reducing metal catalyst 20.

FIG. 3(g) is Referred to:

(Step F)

Next, according to an electroless plating method of using an EDTA-containing plating solution 21 that contains ethylenediaminetetraacetate-copper complex (EDTA-Cu), an electroless copper plate layer 22 that is to be a plate seed layer is formed.

EDTA-Cu to be used for the electroless copper plate layer 22 is a solution having a basic composition of from 0.03 to 0.05 mol/liter of Cu, from 1.0 to 2.5 times by mol relative to Cu of EDTA, and from 0.01 to 0.03 mol/liter of formalin, and its pH is adjusted with from 0.3 to 0.6 normalities, preferably from 0.4 to 0.5 normalities of alkali hydroxide.

Preferably, the solution contains other additives, for example, a stabilizer such as α,α′-bipyridyl, or a film improver such as polyethylene glycol or glycine.

Regarding the condition for forming the metal thin-film layer, the temperature of the electroless plating solution falls between 50 and 70° C.; the plate thickness is suitably selected from a range falling between 0.1 μm and 20 μm, preferably between 0.3 μm and 10 μm.

FIG. 3(h) is Referred to:

(Step G)

Next, on the electroless copper plate layer 22 formed in the step E, for example, a plate resist (not shown) is formed according to an ordinary method; and then an electrolytic copper plate layer 23 is grown on it through wet plating such as electrolytic plating. Next, the plate resist is removed, and then the exposed electroless copper plate layer 22 is etched away to form a conductor circuit layer (not shown).

The conductor circuit layer is composed of the electroless copper plate layer 22 and the electrolytic copper plate layer 23 formed on it.

(Step H)

Next, for enhancing the adhesion of the conductor circuit layer in the invention, the inner layer board 11 with the electroless copper plate layer 22 formed thereon, or the inner layer board 11 with the conductor circuit layer formed on the electroless copper plate layer 22 thereon may be heated, for example, in an oven or a hot air-drying furnace.

The temperature is preferably at around the glass transition temperature of the electrical insulating layer 15, generally falling between 50 and 350° C., preferably between 80 and 250° C.

The multilayer circuit board thus obtained herein may be used as printed wiring boards to carry semiconductor devices such as CPU and memories or other packaging parts mounted thereon in electronic appliances such as computers or portable telephones.

In particular, those with micropatterned wiring are used as high-density printed wiring boards and are favorable for high-speed computers and for portable terminals that are driven in high-frequency ranges.

The concrete constitution of the invention is described with reference to the following Examples and Comparative Examples. Before this, the evaluation methods performed in the examples are described below.

In the examples, “part” and “%” are by weight, unless otherwise specifically indicated.

The evaluation methods performed in the examples are as follows.

<1> Molecular Weight (Mw, Mn):

the molecular weight was measured as a value in terms of polystyrene by gel permeation chromatography (GPC) using toluene as a solvent.

<2> Hydrogenation Ratio and Maleic Acid (Anhydride) Residue Content:

The ratio of hydrogenation to the number of moles of unsaturated bonds in a polymer before hydrogenation (hydrogenation ratio) and the ratio of the number of moles of maleic acid (anhydride) to the total monomer units in the polymer (carboxyl group content) were measured by ¹H-NMR spectroscopy.

<3> Glass Transition Temperature (Tg):

The glass transition temperature (Tg) was measured by differential scanning calorimetry (DSC).

<4> Evaluation of Plate Adhesion:

An electrolytic copper plate film having a thickness of 18 μm was formed through electrolytic plating, and this was heated at 170° C. for 30 minutes to form a conductor circuit. Its adhesion was evaluated according to a 90-degree peeling test of JIS (JIS C-6481) that indicates a peeling strength of copper foil.

<5>Evaluation of Surface Roughness:

The surface roughness Ra was measured and evaluated by the use of an atomic force microscope (Nanoscope 3a, trade name, made by Digital Instrument) using an Si single crystal strip cantilever (spring constant=20 N/m, length 125 μm) in a tapping mode in air.

Based on the matters as above, concrete examples and comparative examples are described below.

### EXAMPLE 1

First, a curable composition comprising 100 parts of a modified hydrogenated polymer (Mn=33,200, Mw=68,300, Tg=170° C., maleic acid residue content=25 mol %) that had been prepared by hydrogenating a ring-opened polymer of 8-ethyl-tetracyclo[4.4.0.1^{2,5}.1^{7,10}]-dodec-3-ene and further modified with maleic anhydride, 40 parts of bisphenol A bis (propylene glycol glycidyl ether) ether, 5 parts of 2-[2-hydroxy-3,5-bis(α,α-di-methylbenzyl)phenyl]-benzotriazole and 0.1 parts of 1-benzyl-2-phenylimidazole was dissolved in a mixed solvent of 215 parts of xylene and 54 parts of cyclopentanone to obtain a varnish.

Next, using a die coater, the varnish was applied onto a carrier film, a polyethylene naphthalate film having a size of 300 mm×300 mm and a thickness of 40 μm, and then this was dried in a nitrogen oven, for example, at 120° C. for 10 minutes to obtain a carrier film-supported dry film having a resin thickness of 40 μm.

On the other hand, a 0.1% solution of di-n-butylamino-4,6-dimercapto-S-triazine in isopropyl alcohol was prepared. A double-sided copper-clad board having a thickness of 0.8 mm and having an inner layer circuit formed thereon, in which the wiring width and the distance between the wirings were both 50 μm and the conductor thickness was 18 μm and which was microetched on the surface (the board is a core material obtained by infiltrating a varnish that contains a glass filler and a halogen-free epoxy resin into a glass cloth) was dipped in the solution at 25° C. for 1 minute. Next, this was dried in a nitrogen-purged oven at 90° C. for 15 minutes to form a primer layer, and an inner layer board was thus obtained.

Next, on the inner layer board, the carrier film-supported dry film was bonded together on both sides of the double-sided copper-clad board such that the resin surface could be inside.

This was subjected to thermo-compression bonding, using a vacuum laminator provided with press plates made of a heat resistant rubber at the top and the bottom thereof, under a reduced pressure of 200 Pa, at a temperature of 125° C. and a pressure of 0.5 MPa for 60 seconds, whereby a curable composition film was formed on the inner layer board. Then, only the polyethylene naphthalate film was peeled away from the board thus having the curable composition film formed thereon.

Next, this was dipped in an aqueous solution of 1-(2-aminoethyl)-2-methylimidazole (AMZ) having a controlled concentration of 0.3%, at 25° C. for 10 minutes, and then dipped in a separate water tank for 1 minute. The washing operation was repeated three times, and then the excess solution was removed from it with an air knife. This was left in a nitrogen oven at 170° C. for 60 minutes, whereby an electrical insulating layer was formed on the inner layer board.

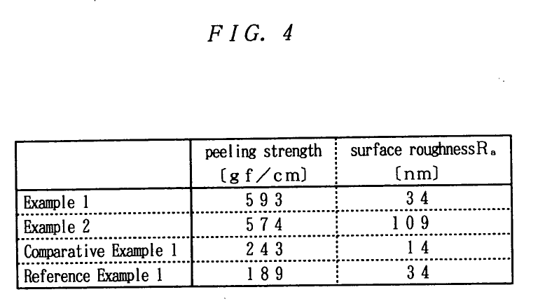

In this condition, the surface roughness of the electrical insulating layer was evaluated, and the result is shown in FIG. 4.

Next, in the electrical insulating layer of the board thus having the electrical insulating layer formed thereon, via-holes were formed for interlayer connection, having a diameter of, for example, 30 μm, by the use of UV rays of third harmonics of YAG laser (THG), therefore obtaining a multilayer board with via-holes.

Next, the multilayer board with via-holes was dipped in an aqueous solution at 80° C. for 5 minutes that had been adjusted so as to have a concentration of permanganic acid of 80 g/liter and a concentration of sodium hydroxide of 40 g/liter.

Next, the board was dipped in a water bath for 1 minute, and this operation was repeated twice. Further, the board was ultrasonicated in another water bath at 25° C. for 2 minutes. In that manner, the board was washed with water, and then dipped inanaqueous solution at 45° C. for 5 minutes that had been adjusted so as to have a concentration of hydroxylamine sulfate of 20 g/liter and sulfuric acid of 50 g/liter, whereby the board was neutralized and reduced. Then, this washed with hot water at 60° C. for 10 minutes.

Next, the thus-washed multilayer board was dipped in a predipping solution at 25° C. for 1 minute that had been adjusted so as to contain 20 ml/liter of Predip Neogant B (trade name, made by Atotech) and to have a concentration of sulfuric acid of 1 ml/liter, and then dipped in a Pd salt-containing plating catalyst solution at 50° C. for 5 minutes that had been adjusted so as to contain 30 ml/liter of Activator Neogant 834 Conc (trade name, made by Atotech) and to have a concentration of boric acid of 5 g/liter and have a pH of 11.0 controlled by a concentration of sodium hydroxide therein.

Next, the board was washed with water in the same manner as above, and then dipped in a solution at 30° C. for 5 minutes that had been adjusted so as to contain 5 ml/liter of Reducer Neogant WA (trade name, made by Atotech) and to have a concentration of boric acid of 25 g/liter, whereby the plating catalyst was reduced.

The thus-obtained multilayer board was subjected to electroless plating treatment by dipping it in an electroless plating bath comprising an electroless copper plating liquid KC-500 (trade name, made by Japan Energy) at a temperature of 60° C. for 15 minutes that had been adjusted so as to have a basic composition comprising 2.3 g/liter of Cu metal, 20 g/liter of EDTA and 1.0 g/liter of formalin and to have a pH of 12.5 controlled by sodium hydroxide therein, with bubbling with air introduced thereinto, whereby an metal thin-film layer was thus formed. Next, the multilayer board thus having the metal thin-film layer formed thereon through the electroless plating treatment was washed with water in the same manner as above.

Next, this was subjected to rust-proofing treatment by dipping it in a rust-proofing solution at 25° C. for 1 minute that had been adjusted so as to contain 8 ml/liter of OPC Defenser (trade name, made by Okuno Pharmaceutical), then further washing it with water in the same manner as above, and drying it.

Next, a commercially-available dry film of photoresist was thermally bonded under pressure to the surface of the multilayer board thus processed for rust-proofing, and then a mask of a pattern corresponding to the pattern for adhesion evaluation was airtightly applied onto the dry film, and this was exposed to light in that condition and developed to obtain a resist pattern.

Next, this was dipped in a solution of 100 g/liter of sulfuric acid at 25° C. for 1 minute to remove the rust-proofing agent, and then subjected to selective electrolytic copper plating via the resist pattern serving as a mask to thereby form an electrolytic copper plate film having a thickness of, for example, 18 μm.

Next, the resist pattern was stripped away with a stripping solution, and then the board was etched with a mixed solution of cupric chloride and hydrochloric acid, whereby the exposed portion of the metal thin-film layer was removed to form a wiring pattern of electrolytic copper plate film/metal thin-film layer (conductor circuit layer). Next, this was heated in an oven at 170° C. for 30 minutes to obtain a double-sided multilayer circuit board having a wiring pattern on both faces thereof.

The result of adhesion evaluation of the thus-obtained multilayer circuit board is shown in FIG. 4.

In that manner, in Example 1 of the invention, the adhesion strength of 593 gf/cm that causes no problem in practical use can be obtained even though the surface roughness Rₐ of the electrical insulating layer 15 is 34 nm, or that is, the layer is extremely smooth, since the board is processed through a series of procedure of formation of a layer that contains a compound capable of coordinating to a metal—high-concentration and short-time hydrophilication treatment—EDTA-type electroless plating treatment.

Next, Example 2 is described below, in which only the concentration in AMZ treatment in Example 1 was changed but the other constitution is entirely the same as in the above-mentioned Example 1 and its description is simplified.

### EXAMPLE 2

In the same manner as in Example 1, a double-sided multilayer circuit board having a wiring pattern on both faces thereof was obtained except for the following: A curable composition film was formed in the same manner as in Example 1, and then only the polyethylene naphthalate film was peeled away. In place of dipping it in an aqueous solution of 1-(2-aminoethyl)-2-methylimidazole at 25° C. for 10 minutes that had been adjusted so as to have a concentration of 0.3% as in Example 1, the board was dipped in the aqueous solution at 25° C. for 10 minutes that had been adjusted so as to have a concentration of 1.0%.

The result of adhesion evaluation of the thus-obtained multilayer circuit board is shown in FIG. 4.

In that manner, in Example 2 of the invention where the AMZ concentration was increased to about 3.3 times, the adhesion strength of 574 gf/cm that is almost the same as in Example 1 was obtained.

However, since the AMZ concentration was high, the surface roughness Rₐ of the electrical insulating layer increased.

### COMPARATIVE EXAMPLE 1

After a curable composition film was formed on an inner layer board according to the same process as in Example 1, only the polyethylene naphthalate film was peeled away from the board having the curable composition formed thereon. Next, this was left in a nitrogen oven at 170° C. for 60 minutes, thereby forming an electrical insulating layer on the inner layer board.

The result of evaluation of the surface roughness of the electrical insulating layer in this stage is shown in FIG. 4.

Next, a double-sided multilayer circuit board having a wiring pattern on both faces thereof was obtained according to the same process as in Example 1, and the plate adhesion of the thus-obtained multilayer circuit board was evaluated.

The result of peeling strength is shown in FIG. 4.

In that manner, in Comparative Example 1 where the AMZ treatment was not carried out but only the hydrophilication treatment was carried out, the adhesion strength of only 243 gf/cm or so was obtained. From this, it is understood that the AMZ treatment is indispensable.

### REFERENCE EXAMPLE 1

A plating catalyst was applied to a multilayer board having via-holes and having an electrical insulating layer formed on an inner layer board according to the same process as in Example 1, and this was reduced. Thus processed, the multilayer board was dipped in an electroless copper plating liquid having a metal copper concentration of 2.5 g/liter and containing 28 g/liter of Rochelle salt, 20 g/liter of formalin and 1.5 g/liter of NaOH with bubbling with air introduced thereinto, at a plating bath temperature of 36° C. for 15 minutes to thereby form a metal thin-film layer on the multilayer board.

After this, the multilayer board was processed in the same manner as in Example 1, and it gave a double-sided multilayer circuit board having a wiring pattern on both faces thereof. The plate adhesion of the thus-obtained multilayer circuit board was evaluated.

The result of peeling strength is shown in FIG. 4.

In that manner, in Reference Example 1 where a plate seed layer was formed by the use of a different electroless plating solution, it was found that the peeling strength was 189 gf/cm or so.

From this point, it is understood that use of EDTA-containing plating solution is effective as the electroless plating solution in the electroless plating step.

Some embodiments of the invention have been described hereinabove, but the invention should not be limited to the constitution and the condition described in the embodiments. In the invention, various modifications and changes are possible.

For example, the above-mentioned Examples are to demonstrate a process for manufacturing multilayer printed wiring boards. However, the invention is not limited to multilayer printed wiring boards, but may be applicable to interposers that are to be between a printed wiring board and a semiconductor chip.

Further, the inner layer board includes semiconductor board, and the invention is applicable to multilayer wiring structures in semiconductor integrated circuit devices.

Specifically, the recent tendency in the art is toward high-integration and high-speed semiconductor devices, and the constitutive elements of semiconductor integrated circuit devices are much more micropatterned. Accordingly, the wiring density is increasing, and multi-level wiring with thin films is desired, and, in addition, the stress to such wirings and the density of current running through the wirings are much more increasing.

High-density current that runs though wirings causes electromigration which means breakage of wirings. Therefore, with the increase in the micropatterned devices, it has become necessary to obtain wiring materials of high reliability that allow higher-density current to run through them.

Heretofore, Al is used as the wiring material for integrated circuit devices since its production process is simple and it is inexpensive. However, the increase in signal delay that may be caused by micropatterning of wirings must be prevented, and the resistance of Al having an electric resistivity of 2.70 μΩ·cm is not always satisfactorily low. Accordingly, use of Cu (electric resistivity: 1.55 μΩ·cm) of which the electric resistivity is smaller than that of Al and the electromigration resistance is about 2 times that of Al is investigated.

Further, in order to reduce the signal delay that may becaused by micropatterning of wiring layers and by high-density wiring, it is indispensable to reduce the dielectric constant of interlayer insulating films. Using the electrical insulating layer in the invention makes it possible to reduce the dielectric constant of interlayer insulating films, and, in addition, using the Cu plate film formed through a process of AMZ treatment—hydrophilication treatment—EDTA electroless plating step makes it possible to increase the adhesion of the wiring layers. Moreover, the method for forming multilayer wiring structures of the invention is advantageous when the entire structure is formed at low temperatures not higher than 500° C.

### INDUSTRIAL APPLICABILITY

As in the above, the method for forming a multilayer circuit structure and the substrate having a multilayer circuit structure of the invention are suitable for realizing multilayer wiring boards that have an adhesion strength enough for practical use. In particular, they are suitable for realizing multilayer wiring boards for GHz-order high-speed transmission.

1. A method for forming a multilayer circuit structure, which comprises steps of forming a curable composition film that contains an insulating polymer and a curing agent, as the outermost layer of an inner layer board, then bringing a compound that has a structure capable of coordinating to a metal, into contact with the surface of the curable composition film, then curing the curable composition film to form an electrical insulating layer, then hydrophilicating the surface of the resulting electrical insulating layer, then forming a metal thin-film layer of an ethylenediaminetetraacetate-copper complex on the surface of the electrical insulating layer, and then forming a conductor circuit layer that contains the metal thin-film layer.

2. The method for forming a multilayer circuit structure as claimed in claim 1, wherein the hydrophilicating treatment step is a step of bringing the electrical insulating layer into contact with a mixture solution that comprises from 65 g/liter to 150 g/liter of potassium permanganate and from 0.75 normalities to 1.5 normalities of an alkali hydroxide, for surface-treatment of the electrical insulating layer.

3. The method for forming a multilayer circuit structure as claimed in claim 1, wherein the curable composition film that contains an insulating polymer and a curing agent and is formed as the outermost layer of the inner layer board is formed according to any of a method of laminating any of a shaped film or sheet of a curable composition that contains an insulating polymer and a curing agent, on the inner layer board, or a method of by applying a varnish prepared by dissolving a curable composition containing an insulating polymer and a curing agent in a solvent, onto the surface of the inner layer board and drying it thereon.

4. The method for forming a multilayer circuit structure as claimed in claim 1, which includes a step of heating the inner layer board with the conductor circuit layer formed thereon, after the step of forming the conductor circuit layer.

5. A substrate having a multilayer circuit structure, in which the multilayer circuit structure is manufactured according to the multilayer circuit structure-forming method of claim 1.
